(19) United States
(12) Patent Application Publication
(10) Pub. No.: US 2026/0016352 A1
(43) Pub. Date: Jan. 15, 2026

(54) RESILIENT FORCE SENSOR UNIT

(71) Applicant: UNEO INC., Taipei (TW)

(72) Inventors: Han-Ying LEI, Taipei (TW); Chia-Hung CHOU, Taipei (TW); Chih-Sheng HOU, Taipei (TW)

(21) Appl. No.: 18/769,400

(22) Filed: Jul. 11, 2024

(51) Int. Cl. G01L 1/22

(52) U.S. Cl. CPC G01L 1/2268; G01L 1/2287

(57) ABSTRACT

A resilient force sensor unit is disclosed, the force sensor unit has a thin film force sensing element sandwiched between a top substrate and a bottom substrate. A first protective layer is configured on a bottom surface of the bottom substrate, and a second protective layer is configured on a top surface of the top substrate. The protective layer helps prevent potential creases or wrinkles from occurring on the force sensor unit. Complete folding of the sensor device becomes less possible due to the additional thickness/hardness of the stacked material layers, thereby lowering the chance a crease is formed during use.

### BACKGROUND

### Technical Field

The present invention pertains to force sensor units, particularly a resilient force sensor unit equipped with at least one protective layer on a top surface and/or a bottom surface of the force sensor unit. The protective layer is configured to minimize the formation of creases or wrinkles from occurring on the force sensor unit.

### Description of Related Art

FIGS. 1A-1B, and 2 show prior art

FIG. 1A shows a top view of a prior art

FIG. 1A shows a traditional force sensor mat 100 which comprises a plurality of force sensor units 15 arranged in a matrix format. Circuitry 12 electrically couples the force sensing element 11 to a plurality of gold fingers 13. These gold fingers 13 transmit force signals from each force sensing element 11 to an external control unit for further processing.

FIG. 1B shows a side view of the prior art

FIG. 1B shows a side view of the prior art force sensor mat 100, where a wrinkle, denoted as W, may appear after prolonged use by a patient lying on it to assess a distribution of body force.

FIG. 2 shows a section view according to line AA′ of FIG. 1A

FIG. 2 shows a sectional view of two force sensor units 15 for explaining the structure of the force sensor mat 100. The sectional view shows a stake of a top substrate 14T and a bottom substrate 14B, and two force sensing elements 11 are sandwiched between the top substrate 14T and the bottom substrate 14B. Each force sensing element 11 is responsible for detecting and measuring a force applied to it from top or bottom of a corresponding force sensor unit 15. The thickness of the traditional force sensor mat 100 is around 0.05˜2.00 mm.

One of the disadvantages of the prior art is illustrated in FIG. 1B, where wrinkles W may develop after prolonged use by a patient lying on the force sensor mat 100.

### SUMMARY OF THE INVENTION

A force sensor mat, composed of a plurality of force sensor units, can be used to measure distribution of body forces from a patient lying on the mat. However, the force sensor mat often suffers from issues such as creasing, wrinkling or folding after prolonged use. The creasing, wrinkling or folding can lead to inaccuracies in the force measurements and reduce the lifespan of the force sensor mat. The present invention discloses a thin film force sensor mat that includes a top thin film substrate and a bottom thin film substrate, and a plurality of force sensing elements are sandwiched between the top thin film substrate and the bottom thin film substrate. A top protective layer is configured on a top surface of the top substrate, and a bottom protective layer is configured on a bottom surface of the bottom substrate. This ensures that creases or wrinkles will not occur within a certain period, even after prolonged use of the force sensor mat according to the present invention.

### BRIEF DESCRIPTION OF THE DRAWINGS

FIGS. 1A-1B, and 2 shows a prior art.

FIG. 3 shows a first embodiment according to the present invention.

FIG. 4 shows a second embodiment according to the present invention.

FIGS. 5-6 shows a third embodiment according to the present invention.

FIG. 7 shows a fourth embodiment according to the present invention.

FIGS. 8-9 show a fifth embodiment according to the present invention.

FIG. 10 shows a sixth embodiment according to the present invention.

FIGS. 11-12 show a seventh embodiment according to the present invention.

FIG. 13 shows an eighth embodiment according to the present invention.

FIG. 14 shows positions of fixing units according to the present invention.

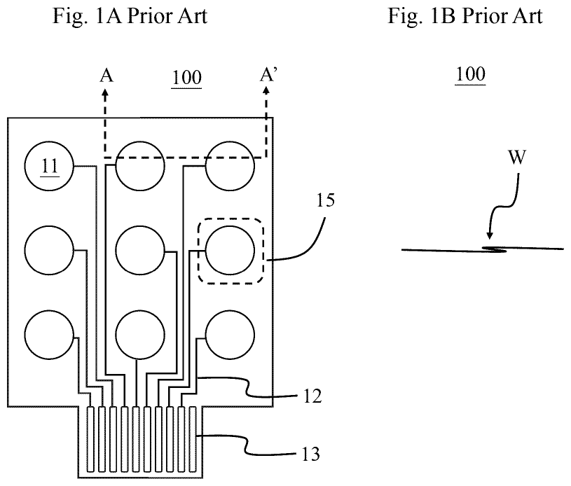

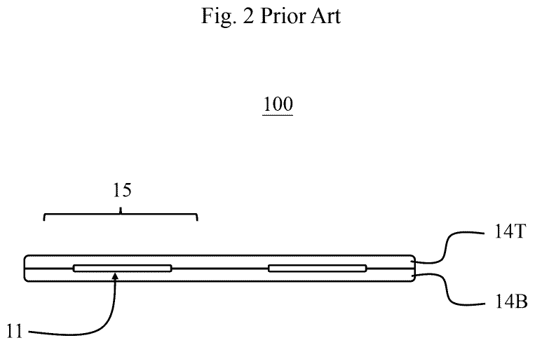

### DETAILED DESCRIPTION OF THE INVENTION

The force sensor mat, as produced by the current invention, exhibits at least the following performance traits:
(1) The ability to uphold measurement precision in environments with high temperatures, specifically within a range of −40° C. to 85° C.;
(2) The capacity to operate reliably in environments with high humidity, specifically within a range of 10% to 90% RH; and
(3) The resilience to resist deformation under external forces in high-pressure environments, specifically within a range of 0 to 10 MPa.

Beyond the medical application as described as above, the force sensor mat, as per the current invention, has more potential applications in various fields, including industrial automation, sports equipment, and smart furniture, among others.”

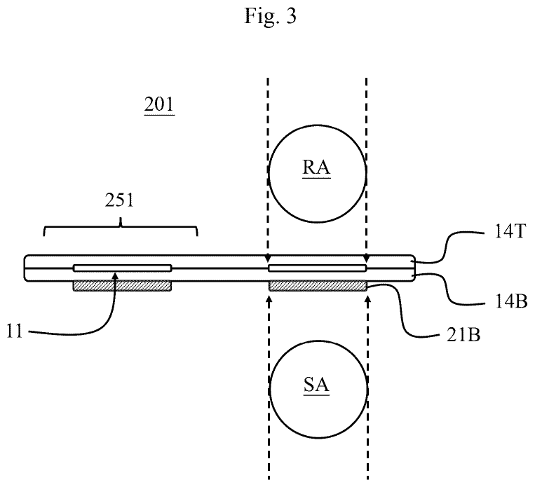

### FIG. 3 Shows a First Embodiment According to the Present Invention.

FIG. 3 shows a sectional view of two force sensor units 251 of a resilient film-type force sensor mat 201 which is designed to measure force with high precision and reliability. The force sensor mat 201 comprises a top thin film substrate 14T and a bottom thin film substrate 14B. A plurality of thin film force sensing elements 11 are sandwiched between the top thin film substrate 14T and a bottom thin film substrate 14B. Each force sensing element 11 is responsible for detecting a force applied to it from top or bottom. The force sensing element 11 is electrically coupled with a first circuitry (not shown) on the top thin film substrate 14T and a second circuitry (not shown) on the bottom thin film substrate 14B, allowing it to communicate the measured force to an external control unit (not shown) for further processing.

To enhance the durability and resilience of the force sensor mat 201, a bottom protective layer 21B is configured on a bottom surface of the bottom thin film substrate 14B. The bottom protective layer 21B, which does not have any circuitry on it, has a Young's modulus of 0.1˜200 GPa. The Young's modulus is a measure of the stiffness of a material, and in this case, it indicates that the bottom protective layer 21B is configured to help the force sensor unit 251 resist creasing, folding, or wrinkling from bottom.

The bottom protective layer 21B is configured under and aligned with a corresponding force sensing element 11 above.

The bottom protective layer 21B has a surface area SA from a bottom view that is roughly between 0.4˜2.5 times of the responsive area RA of the force sensing element 11. This configuration ensures that the bottom protective layer 21B can adequately protect the force sensor unit 251 from being creased, folded, or wrinkled from bottom.

In a typical design, the bottom protective layer 21B has a surface area SA that is roughly the same as the responsive area RA of the force sensing element 11.

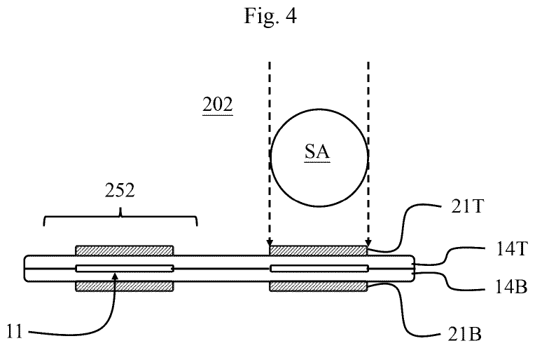

### FIG. 4 Shows a Second Embodiment According to the Present Invention.

FIG. 4 shows a sectional view of two force sensor units 252 of a resilient film-type force sensor mat 202.

FIG. 4 is based on FIG. 3, a top protective layer 21T is further prepared and then configured on a top surface of the top thin film substrate 14T.

The top protective layer 21A, which does not have any circuitry on it, has a Young's modulus of 0.1˜200 GPa. The Young's modulus is a measure of the stiffness of a material, and in this case, it indicates that the top protective layer 21A is used to help the force sensor unit 252 resist creasing, folding, or wrinkling from top.

The top protective layer 21T is configured over and aligned with the corresponding force sensing element 11 below.

The top protective layer 21T has a surface area SA that is roughly between 0.4˜2.5 times of the responsive area RA of the force sensing element 11. This configuration ensures that the top protective layer 21T can adequately protect the force sensor unit 252 resist creasing, folding, or wrinkling from top.

In a typical design, the top protective layer 21T has a surface area SA that is roughly the same as the responsive area RA of the force sensing element 11.

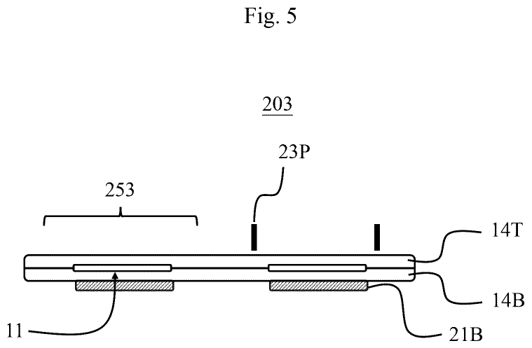

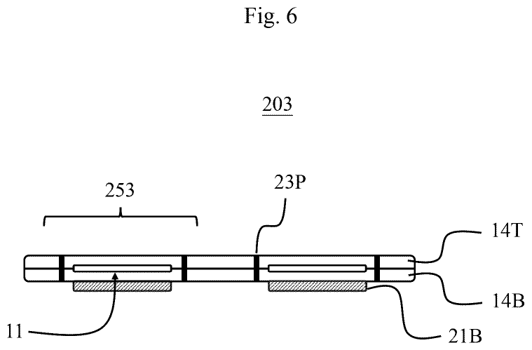

### FIGS. 5-6 Show a Third Embodiment According to the Present Invention.

FIG. 5 shows a sectional view of two force sensor units 253 of a resilient film-type force sensor mat 203.

FIG. 5 shows that, to prevent the top thin film substrates 14T and the bottom thin film substrate 14B from becoming misaligned, at least one fixing pin 23P is prepared, and the fixing pin 23P is then inserted and penetrates through both the top thin film substrates 14T and the bottom thin film substrate 14B, holding the two substrates in place.

FIG. 5 shows fix pins 23P which can be made of metal or non-metal. The fix pins 23P can be inserted into the top thin film substrate 14T and the bottom thin film substrate 14B using a hammer, stapler or similar tools.

FIG. 6 shows fixing pins 23P are inserted in the top thin film substrate 14T and the bottom thin film substrate 14B to hold the two substrates in place and prevent misalignment between the two substrates.

In a typical embodiment, the fixing pin 23P has a length that covers a thickness roughly the same as a total thickness of the top thin film substrate 14A and the bottom thin film substrate 14B.

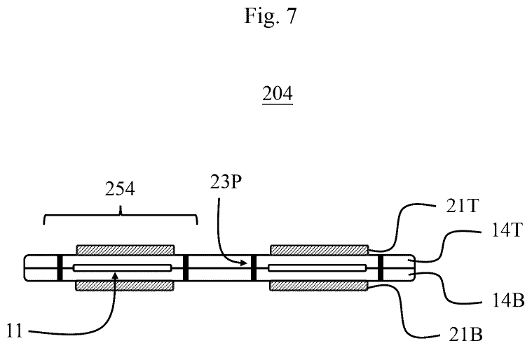

### FIG. 7 Shows a Fourth Embodiment According to the Present Invention.

FIG. 7 shows a sectional view of two force sensor units 254 of a resilient film-type force sensor mat 204.

FIG. 7 is based on FIG. 6, a top protective layer 21T is further prepared and then configured on a top surface of the top thin film substrate 14T.

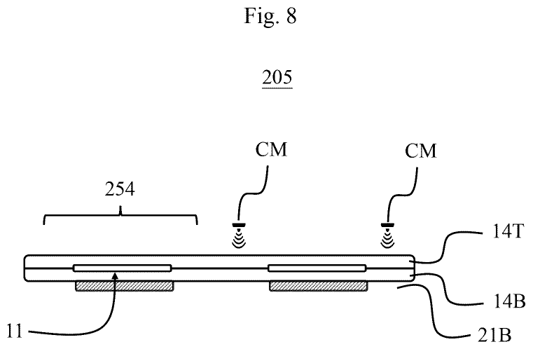

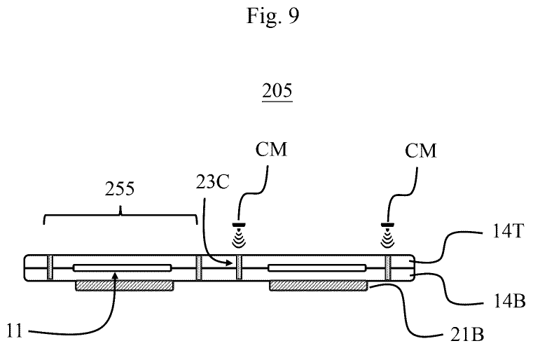

### FIGS. 8-9 Show a Fifth Embodiment According to the Present Invention.

FIG. 8 shows a sectional view of two force sensor units 254 of a resilient film-type force sensor mat 205.

An IR curing machine CM is prepared to cure designated locations of the top thin film substrate 14T with the bottom thin film substrate 14B.

FIG. 9 shows that radiation-cured resin columns are formed.

Radiation-cured resin columns can be made through IR radiation or UV radiation at designated locations. In this process, the top thin film substrate 14T and the bottom substrate 14B are exposed to radiation at designated locations, causing them to cure and form radiation-cured resin columns 23C.

FIG. 9 shows radiation-cured resin columns 23C, which function similarly to the fixing pin 23P, to hold the top thin film substrate 14A and bottom thin film substrate 14B in place.

In a typical embodiment, the radiation-cured resin columns 23C has a length that covers a thickness roughly the same as a total thickness of the top thin film substrate 14A and the bottom thin film substrate 14B.

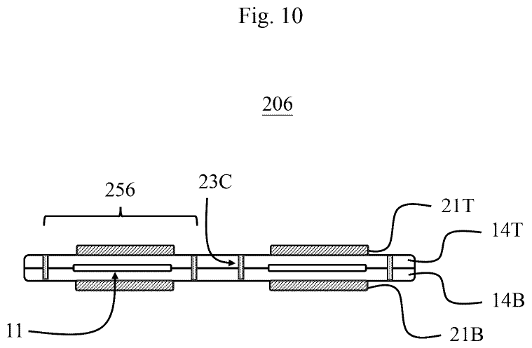

### FIG. 10 Shows a Sixth Embodiment According to the Present Invention.

FIG. 10 shows a sectional view of two force sensor units 256 of a resilient film-type force sensor mat 206.

FIG. 10 is based on FIG. 9, a top protective layer 21T is further prepared and then configured on a top surface of the top thin film substrate 14T.

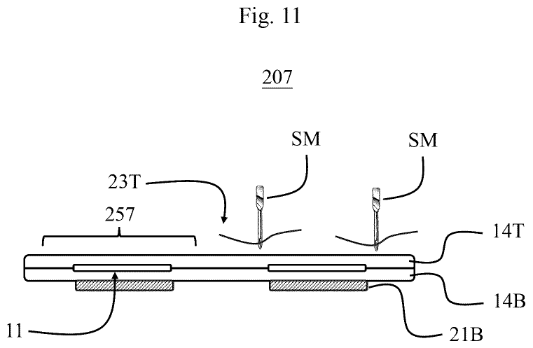

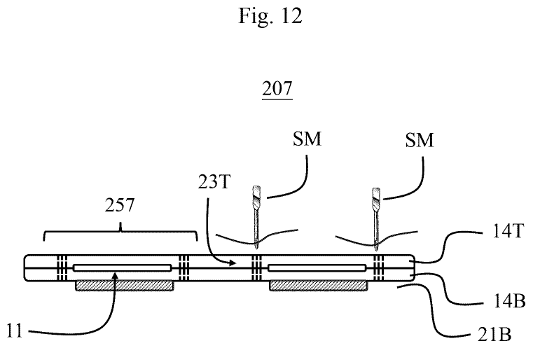

### FIGS. 11-12 Show a Seventh Embodiment According to the Present Invention.

FIG. 11 shows a sectional view of two force sensor units 257 of a resilient film-type force sensor mat 207.

A sewing machine SM is used to sew the top thin film substrate 14T with the bottom thin film substrate 14B with a sewing thread 23T.

FIG. 12 shows that sewing threads 23T are formed.

The sewing threads 23T are formed to combine the top thin film substrate 14T and the bottom thin film substrate 14B. These sewing threads 23T function similarly to the fixing pin 23P to hold the top thin film substrate 14A and bottom thin film substrate 14B in place.

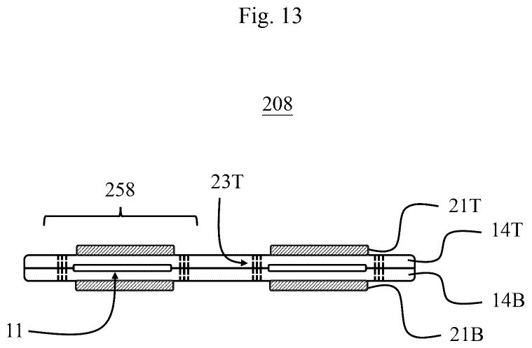

### FIG. 13 Shows an Eighth Embodiment According to the Present Invention.

FIG. 13 shows a sectional view of two force sensor units 258 of a resilient film-type force sensor mat 208.

FIG. 13 is based on FIG. 12, a top protective layer 21T is further prepared and then configured on a top surface of the top thin film substrate 14T.

In a typical embodiment, the sewing thread 23T suturing a length that covers a thickness roughly the same as a total thickness of the top thin film substrate 14A and bottom thin film substrate 14B. This ensures that the sewing thread 23T can securely hold the top thin film substrate 14A and bottom thin film substrate 14B in place.

Both the top protective layer 21T and the bottom protective layer 21B have a Young's modulus of 0.1˜200 GPa.

Both the top protective layer 21T and the bottom protective layer 21B have a thickness that is roughly between 0.1˜2.0 mm. This thickness contributes to the substrates' crease resistance while keeping the overall unit thin and lightweight.

Both the top protective layer 21T and the bottom protective layer 21B can be flexible, non-flexible, or a combination thereof.

Both the top protective layer 21T and the bottom protective layer 21B can be metal, non-metal, or a combination thereof. The choice of material depends on the specific requirements of an application.

Finally, the total thickness of the top protective layer 21T plus the bottom protective layer 21B is roughly between 0.2˜4.0 mm. This thickness ensures that the force sensor mat remains thin and lightweight while still being robust and resilient.

In a typical design for the force sensor unit 251˜258, the thickness of the top protective layer 21T compared to that of the bottom protective layer 21B is roughly between 0.5 and 2. For example: 0.1 mm compared to 0.2 mm, the ratio of which is 0.5; 1 mm compared to 1 mm, the ratio of which is 1; and 1.6 mm compared to 0.8 mm, the ratio of which is 2.

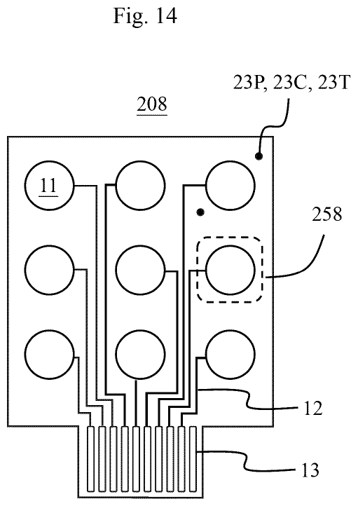

### FIG. 14 Shows Positions of Fixing Units According to the Present Invention.

FIG. 14 shows the fixing units 23X (23P, 23C, 23T) are configured at designated locations to avoid touching circuitries of the force sensor mat 20X (201˜208).

While several embodiments have been described by way of example, it will be apparent to those skilled in the art that various modifications can be made without departing from the spirit of the appended claims.

### NUMERAL SYSTEM

100: Force sensor mat
11: Force sensing element
12: Circuitry
13: Gold Fingers
14T: Top thin film substrate
14B: Bottom thin film substrate
15: force sensor unit
201˜208: Force sensor mat
21T: Top protective layer
21B: Bottom protective layer
23C: Radiation-cured resin column
23P: Fixing pin
23T: Sewing Thread
251˜258: force sensor unit
CM: Curing Machine
RA: Responsive area
SA: Surface Area
SM: Sewing Machine
W: wrinkles

What is claimed is:

1. A resilient force sensor unit, comprising:
a top thin film substrate;
a bottom thin film substrate;
a thin film force sensing element sandwiched between the top thin film substrate and the bottom thin film substrate, and
a bottom protective layer, configured on a bottom surface of the bottom thin film substrate;
wherein
the force sensing element has a responsive area, when a force is applied to this area from top or bottom, the force sensing element will output a corresponding responsive signal.

2. The force sensor unit as claimed in claim 1, wherein
the bottom protective layer has a surface area roughly between 0.4˜2.5 times of the responsive area of the force sensing element.

3. The force sensor unit as claimed in claim 2, wherein
the bottom protective layer has a surface area roughly the same as the responsive area of the force sensing element.

4. The force sensor unit as claimed in claim 3, wherein
the bottom protective layer has a thickness roughly between 0.1˜2.0 mm.

5. The force sensor unit as claimed in claim 4, wherein
the bottom protective layer has a Young's modulus of 0.1˜200 GPa.

6. The force sensor unit as claimed in claim 5, wherein
the bottom protective layer is flexible, non-flexible, or a combination thereof.

7. The force sensor unit as claimed in claim 6 wherein
the bottom protective layer is metal, non-metal or a combination thereof.

8. The force sensor unit as claimed in claim 1, further comprising:
a top protective layer configured on a top surface of the top thin film substrate.

9. The force sensor unit as claimed in claim 8, wherein
the top protective layer has a surface area roughly between 0.4˜2.5 times of the responsive area of the force sensing element.

10. The force sensor unit as claimed in claim 9, wherein
the top protective layer has a surface area roughly the same as the responsive area of the force sensing element.

11. The force sensor unit as claimed in claim 10, wherein
the top protective layer has a thickness roughly between 0.1˜2.0 mm.

12. The force sensor unit as claimed in claim 11, wherein
a total thickness of the top protective layer plus the bottom protective layer is roughly between 0.2˜4.0 mm.

13. The force sensor unit as claimed in claim 12, wherein
a thickness of the top protective layer compared to a thickness of the bottom protective layer is roughly between 0.5 and 2.

14. The force sensor unit as claimed in claim 13, wherein
the top protective layer has a Young's modulus of 0.1˜200 GPa.

15. The force sensor unit as claimed in claim 8, further comprising:
at least a fixing unit penetrating through the top thin film substrate and the bottom thin film substrate to prevent the two substrates from becoming misaligned.

16. The force sensor unit as claimed in claim 15, wherein
the fixing unit is a sewing thread, metal pin or a radiation-cured resin column.

17. The force sensor unit as claimed in claim 16, wherein
the radiation-cured resin column is an IR radiation-cured resin column or a UV radiation-cured resin column.

18. The force sensor unit as claimed in claim 16, wherein
the fixing unit has a length roughly the same as a total thickness of the top thin film substrate plus the bottom thin film substrate.

19. A resilient force sensor unit, comprising:
a top thin film substrate;
a bottom thin film substrate;
a thin film force sensing element sandwiched between the top thin film substrate and the bottom thin film substrate, and
at least a fixing unit penetrating through the top thin film substrate and the bottom thin film substrate to prevent the two substrates from becoming misaligned.

20. The force sensor unit as claimed in claim 19, further comprising:
a top protective layer configured on a top surface of the top thin film substrate.

21. The force sensor unit as claimed in claim 20, further comprising:
a bottom protective layer configured on a bottom surface of the bottom thin film substrate.
